(19) United States
(12) Patent Application Publication
(10) Pub. No.: US 2026/0121977 A1
(43) Pub. Date: Apr. 30, 2026

(54) MIXING DETERMINISTIC AND ADAPTIVE FORWARDING IN A HIGH-SPEED NETWORK

(71) Applicant: Hewlett Packard Enterprise Development LP, Spring, TX (US)

(72) Inventors: Duncan Roweth, Bristol (GB); Robert L. Alverson, Seattle, WA (US); Edwin Lloyd Froese, Burnaby (CA); Eric R. Borch, Fort Collins, CO (US)

(21) Appl. No.: 18/896,153

(22) Filed: Sep. 25, 2024

(51) Int. Cl. H04L 45/745

(52) U.S. Cl. CPC H04L 45/745

(57) ABSTRACT

A system determines paths through a hierarchical network from a source to a destination. The hierarchical network comprises layers, and each layer includes network devices. The system maps a path to a plurality of bits comprising one or more bits indicating a next-hop network device on the path. A network device in a first layer of the hierarchical network receives a packet indicating a traffic class and a destination address. If the traffic class corresponds to a first type, the system applies a deterministic forwarding algorithm by: identifying a first path mapped to a first plurality of bits, where the destination address includes the first plurality of bits; and forwarding, via the first path, the packet to a next-hop network device indicated by the first plurality of bits. If the traffic class corresponds to a second type, the system forwards the packet in accordance with an adaptive forwarding algorithm.

### STATEMENT OF GOVERNMENT-FUNDED RESEARCH

This application was made with Government support under Contract number H98230-15-D-0022/0003 awarded by the Maryland Procurement Office. The Government has certain rights in this invention.

### BACKGROUND

Special cabling patterns and forwarding schemes may be used in some hierarchical networks to improve performance for some traffic patterns. An example of a hierarchical network is a dragonfly network, in which devices inside a group may be connected in an all-to-all topology (a first layer) and the group structure is replicated. Multiple groups may be connected in an all-to-all topology (a second layer). A dragonfly network may use a mathematically defined cabling pattern and associated forwarding algorithm (“deterministic forwarding”) to improve performance. The path for a particular packet from a source to a destination can be predefined. However, most high performance computing (HPC) environments use adaptive forwarding algorithms, in which the path for a particular packet is chosen dynamically. Currently, no method exists which allows the use of both deterministic and adaptive forwarding algorithms in an HPC environment.

### BRIEF DESCRIPTION OF THE FIGURES

FIG. 1 illustrates an environment which facilitates mixing deterministic and adaptive forwarding in a high-speed network, in accordance with an aspect of the present application.

FIG. 2A illustrates an exemplary dragonfly network, in accordance with an aspect of the present application.

FIG. 2B illustrates a zoomed-in view of a portion of the exemplary dragonfly network of FIG. 2A, in accordance with an aspect of the present application.

FIG. 2C illustrates an exemplary fat-tree network with network devices arranged in a tree-like structure, in accordance with an aspect of the present application.

FIG. 3 illustrates a system with two groups of four switches each, in accordance with an aspect of the present application.

FIG. 4A presents a flowchart illustrating a method which facilitates mixing deterministic and adaptive forwarding in a high-speed network, in accordance with an aspect of the present application.

FIG. 4B presents a flowchart illustrating a method which facilitates mixing deterministic and adaptive forwarding in a high-speed network, continuing from the flowchart in FIG. 4A, in accordance with an aspect of the present application.

FIG. 5 illustrates a computer system which facilitates mixing deterministic and adaptive forwarding in a high-speed network, in accordance with an aspect of the present application.

FIG. 6 illustrates a computer-readable medium which facilitates mixing deterministic and adaptive forwarding in a high-speed network, in accordance with an aspect of the present application.

In the figures, like reference numerals refer to the same figure elements.

### DETAILED DESCRIPTION

Aspects of the present application provide a system which allows a sender to use one or both of deterministic and adaptive forwarding algorithms by extending the addressing scheme.

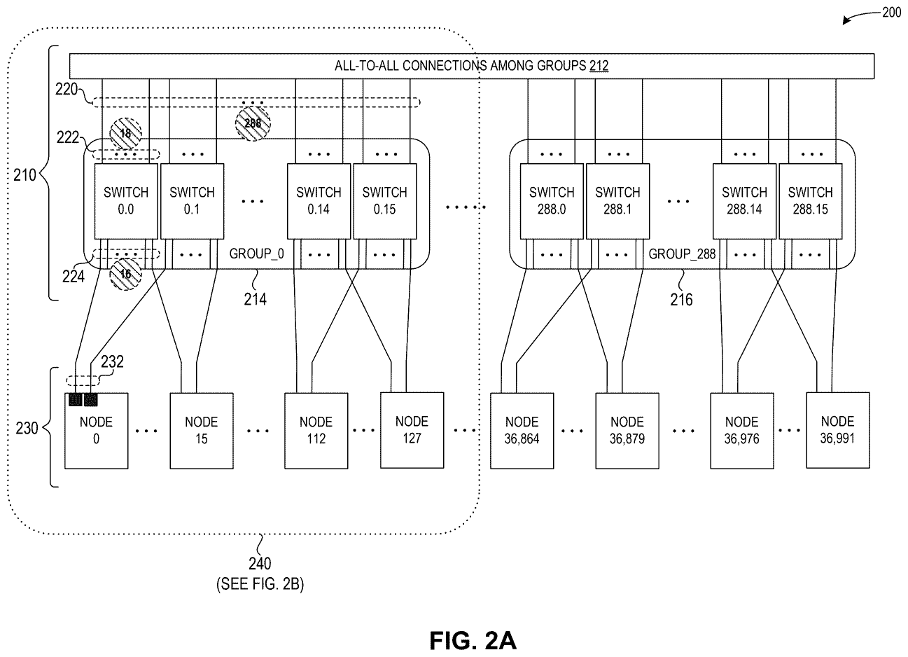

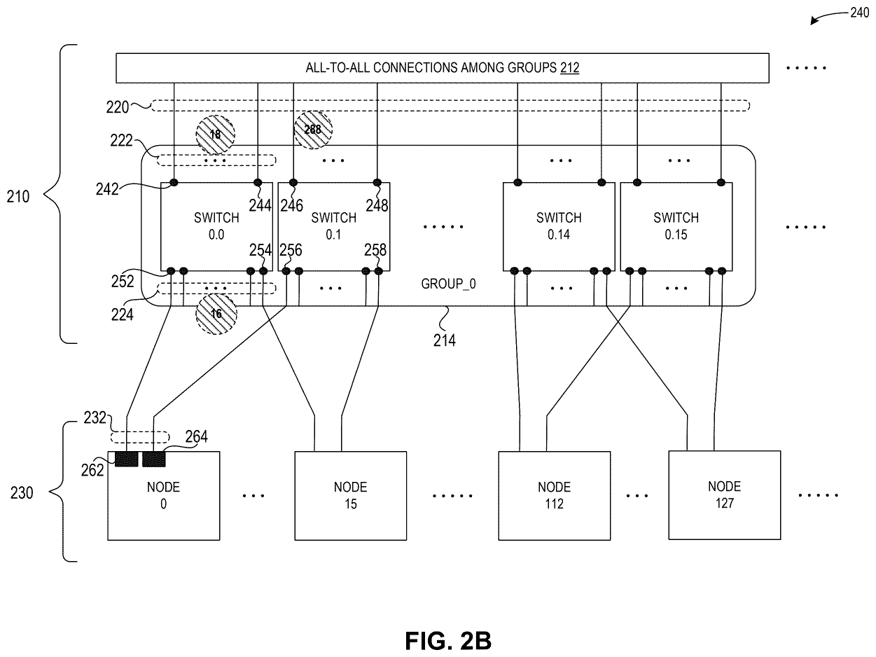

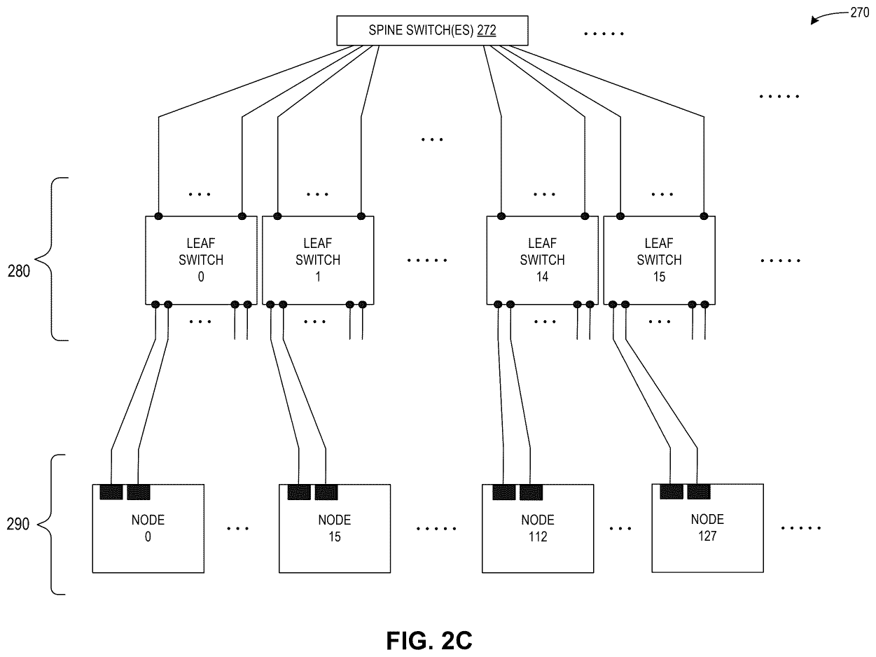

As described above, special cabling patterns and forwarding schemes may be used in some hierarchical networks (such as dragonfly networks) to improve performance. A dragonfly network can include multiple groups of network devices, where all the network devices in a group may be connected in an all-to-all topology (a first layer). The group structure may be replicated, and multiple groups may also be connected in an all-to-all topology (a second layer). An example of a dragonfly network is provided below in relation to FIGS. 2A and 2B. Based on the topology of a dragonfly network, a mathematically defined cabling pattern and associated “deterministic” forwarding algorithm may be used to improve performance, where the path for a particular packet from a source to a destination can be predefined. Deterministic forwarding may provide improvements in some contexts, including systems with specific workloads in informatics or artificial intelligence.

However, most high performance computing (HPC) environments use “adaptive” forwarding algorithms, in which the path for a particular packet is chosen dynamically by the network devices or switches, based on, e.g., current load or congestion information, a destination address, local programming of a switch which may differ from local programming of other switches, etc. Adaptive algorithms may result in improved performance in HPC systems by allowing packets to avoid congestion and flatten network traffic distribution. Currently, no method or system exists which allows the use of both deterministic and adaptive forwarding algorithms in an HPC environment.

The described aspects address these limitations by extending the addressing scheme, e.g., using unused bits in a destination address to allow a sender to indicate or select a specific path from a set of available paths which can be deterministically predetermined based on the topology of the network. As a result, the described aspects can provide a system which may achieve the benefits of improvement from both deterministic forwarding algorithms and adaptive forwarding algorithms in hierarchical networks.

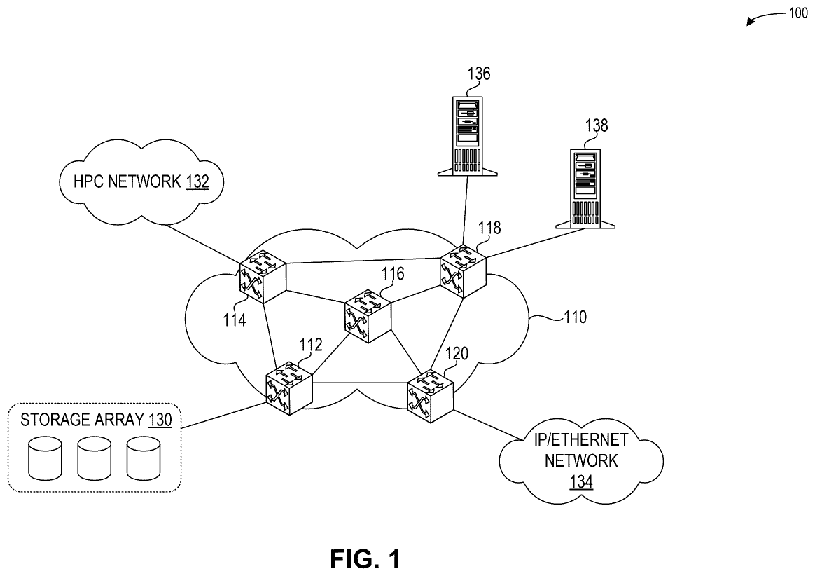

FIG. 1 illustrates a diagram 100 of an exemplary network architecture, in accordance with an aspect of the present application. Diagram 100 can include a network 110 of switches which can be referred to as a “switch fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112; a high performance computing (HPC) network (e.g., InfiniBand, Slingshot, or any other high performance network) 132 may be coupled to switch fabric 110 via switch 114; a number of end hosts, such as hosts 136 and 138, may be coupled to switch fabric 110 via switch 118; and an Internet Protocol (IP)/Ethernet network 134 may be coupled to switch fabric 110 via switch 120. HPC network 132 may include multiple networked computer and storage devices concurrently running programs to complete different complex and performance-intensive tasks. IP/Ethernet network 134 may include physical Ethernet cabling and an application layer protocol between network devices based on IP, including communication via Transport Communication Protocol (TCP)/IP and User Datagram Protocol (UDP) packets.

In general, a switch can have edge ports and fabric ports. An edge port can couple to a device that is external to the fabric. An edge port can operate as an ingress port (when receiving data from the external device) or as an egress port (when transmitting data to the external device). A fabric port can couple to another switch within the fabric via a fabric link. A fabric port can also operate as an ingress port (when receiving data from another switch in the fabric via a fabric link) or as an egress port (when transmitting data to another switch in the fabric via a fabric link). Typically, traffic may be injected into switch fabric 110 via an ingress edge port of a switch and may leave switch fabric 110 via an egress edge port of another (or the same) switch. An ingress link can couple a NIC of an edge device (for example, an HPC end host) to an ingress edge port of a switch in the network fabric. Switch fabric 110 can then transport the traffic to an egress edge port, which in turn can deliver the traffic to a destination edge device via another NIC. A packet can be forwarded in switch fabric 110 based on its Layer-2 address (“fabric address”). In an Ethernet-based switch fabric, the layer-2 address may be an Ethernet media access control (MAC) address. The forwarding path for the packet may be determined using the destination address, local programming of the switches in switch fabric 110, and information related to load, traffic, and congestion available to and associated with switch fabric 110. This type of forwarding may be referred to as “adaptive forwarding.”

In some aspects, switch fabric 110 or HPC network 132 may include network devices (i.e., switches) coupled together in a hierarchical network. An example of a hierarchical network is a dragonfly network, which can include a plurality of groups, each group including a plurality of network devices (i.e., switches). A first layer of the dragonfly network may include the plurality of network devices in a same group which are connected to each other in an all-to-all manner. A second layer of the dragonfly network may include the plurality of groups connected to each other via a plurality of global links in an all-to-all manner. An exemplary dragonfly network is described below in relation to FIGS. 2A and 2B.

FIG. 2A illustrates an exemplary dragonfly network 200, in accordance with an aspect of the present application. FIG. 2B illustrates a zoomed-in view 240 of a portion of the exemplary dragonfly network of FIG. 2A, in accordance with an aspect of the present application. Dragonfly network 200 can be a hierarchical network which includes a plurality of groups, e.g., 289 groups including a group_0 (214) and a group_288 (216) (as indicated by an element 210). Each group can include a plurality of network devices, e.g., group_0 may include 16 switches including a switch 0.0, a switch 0.1, a switch 0.14, and a switch 0.15. The plurality of network devices in a respective group can comprise a first layer of the hierarchical network and may be connected to each other in an all-to-all manner. For example, the 16 switches in group_0 may be connected to each other in an all-to-all manner. The groups in the plurality of groups can comprise a second layer of the hierarchical network and may be connected to each other via a plurality of global links in an all-to-all manner. For example, the 289 groups indicated by element 210 may be connected to each other via 288 global links (as indicated by an element 220 labeled with a count of “288” in the shaded circle), where each of the 16 switches in a respective group have 18 global links (as indicated by an element 222 labeled with a count of “18” in the shaded circle), resulting in 288 global links from one group to each of the other groups. The zoomed-in view 240 of FIG. 2B depicts some of these global links as dark circles, e.g., ports 242 and 244 on switch 0.0 and ports 246 and 248 on switch 0.1.

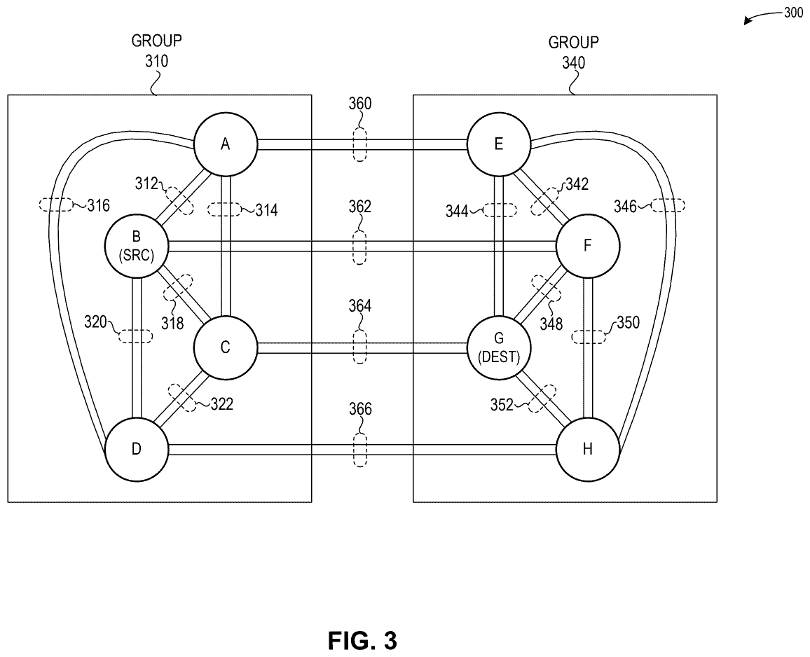

Each network device can be coupled to one or more endpoint or processing nodes, e.g., 36,992 nodes (as indicated by an element 230) including a node 0, a node 15, a node 112, a node 127, a node 36,864, a node 36,879, a node 36,976, and a node 36,991. In the example dragonfly network of FIG. 2A, each node may have two network interface controllers (NICs) (indicated by the pair of dark squares 262 and 264 on node 0 in the zoomed-in detail of FIG. 2B), which can provide connection, coupling, or communication (as indicated by an element 232) with ports or links on the network devices. As depicted in FIGS. 2A and 3B, each network device can include 16 possible ports or links which may be coupled to the one or more endpoint or processing nodes (as indicated by an element 224 labeled with a count of “16” in the shaded circle). The zoomed-in view 240 of FIG. 2B depicts some of these ports as dark circles, e.g., ports 252 and 254 on switch 0.0 and ports 256 and 258 on switch 0.1. For example, as depicted in FIG. 2B, node 0 may include a first NIC 262 which communicates with port 252 of switch 0.0 and a second NIC 264 which communicates with port 256 on switch 0.1. As a result, each node may communicate over two of 16 ports on a network device.

While the number of switches per group is depicted to be the same across all groups in FIGS. 2A and 2B, the number of switches in a group may be different. The topology of the dragonfly network depicted in FIGS. 2A and 2B can result in a cabling pattern which may be mathematically expressed, based on, e.g., the number of switches in a group, the number of groups, the number of global links between groups, the number of endpoint nodes, the number of NICs per endpoint node, etc. For example, dragonfly network 200 may represent a system with groups of switches in physical cabinets in a data center. Given 289 groups, each group may include 16 switches. The 16 switches may be connected to 16*8-128 nodes (e.g., nodes 0-127 or nodes 36,864 to 36,991), where each node has two NICs coupled to ports on two switches of a group. The 16 switches in a group may be connected to the switches in each of the other 288 groups, with 16*18=288 global links between each of the multiple groups. In some aspects, a physical cabinet may include two groups of switches, e.g., 32 switches, connected to 256 nodes. The 289 groups may include a total of 289*16-4,624 switches, connected to 36,992 nodes. In dragonfly network 200 depicted in FIG. 2A, the system may support upwards of approximately 250,000 nodes (i.e., the addressing scheme may include sufficient unused bits to indicate paths in such a scaled-up system), but a topology of such scale may not be desirable, practical, necessary, or affordable.

By using a mathematically defined cabling pattern, the dragonfly network may define and use an associated deterministic forwarding algorithm to improve performance (e.g., the amount, rate, and accuracy of data transfer) within the network. For packets traveling through such a network, the path for a particular packet from a source to a destination can be predefined when using a deterministic forwarding algorithm. Some systems may be designed for specific workloads, e.g., in informatics or artificial intelligence. In such systems, deterministic forwarding may result in improved performance for specific applications.

Aspects of the described system are disclosed in relation to dragonfly networks, but the described aspects may be used on any hierarchical network or Clos network used in a data center. One example of a hierarchical network is a fat-tree network. FIG. 2C illustrates an exemplary fat-tree network 270 with network devices arranged in a tree-like structure, in accordance with an aspect of the present application. Fat-tree network 270 can include: “spine” switch(es) 272, which perform routing and work as the core of the network and may be located at the top of the tree-like structure; leaf switches 280 (including leaf switches 1-15), which may be arranged in one or more hierarchical layers or in groups; and processing or endpoint nodes 290, which may be located at the bottom of the tree-like structure. A number of links going down from a network device to its children network devices may be equal to or greater than a number of links going up to its parent network device (e.g., from the network device and its sibling network devices). The number of network devices (e.g., in spine switches 272, leaf switches 280, and endpoint nodes 290) as well as the depicted links coupling the network devices in fat-tree network 270 are provided for illustrative and non-limiting purposes. The system or a user may select their own paths going “up” the fat-tree network towards the spine switches (e.g., 272), which can result in distributing load in a manner which fits a particular application. Thus, the system or user may apply a hybrid deterministic/adaptive forwarding algorithm, e.g., by applying either a deterministic or adaptive forwarding algorithm in response to any packet traveling up or down the fat-tree network. In practice, opportunities to use adaptive forwarding for packets traveling down the fat-tree structure may be limited, e.g., when choosing between links only on multiple-link cables between a pair of switches. As a packet travels down the fat-tree structure, the packet must traverse specific switches (e.g., 280) in order to arrive at its intended destination. Thus, aspects of the system may be applied to other hierarchical networks in the manner described herein.

Currently, no method exists which allows the use of both deterministic and adaptive forwarding algorithms. The described aspects address this limitation by providing a system which can harness the improvements in performance achieved by both deterministic and adaptive forwarding algorithms by extending the addressing scheme. The addressing scheme can include a destination address with a plurality of unused bits. The described aspects can use the addressing scheme to allow a sender to select or indicate a specific path (among a plurality of available choices for paths) by using the plurality of unused bits in the destination address.

For example, in a system with 16 groups of 16 switches each, and using 14 bits within the destination address to identify the destination switch, six of the 14 switch address bits may be unused. The unused address bits may be used to deterministically select between equivalent paths. Multiple-link cables (such as dual-link or quad-link cables) between each pair of switches may be used in such a system. For example, if dual-link cables are used, one cable may be used between each pair of switches and four cables may be used between each pair of groups. As a result, 2 address bits may be used to select the local switch, 1 address bit may be used to select a link in the cable used to reach that local switch, and up to 3 address bits may be used to select a link to use at each hop. A similar example is provided below in relation to FIG. 3. The number of the “plurality of bits” described herein is provided for illustrative purposes only. Other numbers of bits may be used.

FIG. 3 illustrates a system 300 with two groups 310 and 340 of four switches each, in accordance with an aspect of the present application. System 300 is provided for purposes of illustrating the usage of address bits to identify next hops and paths for applying deterministic forwarding of packets. Other network configurations may be possible. Group 310 can include four switches labeled A, B, C, and D, while group 340 can include four switches labeled E, F, G, and H. The switches in each group may be connected to each other in an all-to-all manner, using dual-link cables (also referred to as “links”) (illustrated with two lines in FIG. 3), and each of the four switches in one group may be connected via a “global” link to one of the four switches in the other group.

For example, in group 310: switch A may be connected with each of switches B, C, and D, via, respectively, links 312, 314, and 316; switch B may be connected with each of switches A, C, and D, via, respectively, links 312, 318, and 320; switch C may be connected with each of switches A, B, and D, via, respectively, links 314, 318, and 322; and switch D may be connected with each of switches A, B, and C, via, respectively, links 316, 320, and 322. Similarly, in group 340: switch E may be connected with each of switches F, G, and H, via, respectively, links 342, 344, and 346; switch F may be connected with each of switches E, G, and H, via, respectively, links 342, 348, and 350; switch G may be connected with each of switches E, F, and H, via, respectively, links 344, 348, and 352; and switch H may be connected with each of switches E, F, and G, via, respectively, links 346, 350, and 352. In addition, system 300 may include all-to-all connections between the groups, e.g.: switch A of group 310 may be connected to switch E of group 340 via a link 360; switch B of group 310 may be connected to switch F of group 340 via a link 362; switch C of group 310 may be connected to switch G of group 340 via a link 364; and switch D of group 310 may be connected to switch H of group 340 via a link 366.

In system 300 in FIG. 3, a packet traveling from a source in one group (e.g., switch B in group 310) to a destination (e.g., switch G in group 340) can take many paths. These possible paths may be described or enumerated using address bits. For example, two address bits (representing up to four values) may be used to select a local switch in group 310 which has global links connected to group 340 (e.g., one of the other local switches A, C, and D in group 310 and the direct path to F in group 340), and a third address bit may be used to specify which link (of the dual-link cable) to use to reach the selected local switch (e.g., which of links 312 to switch A, links 318 to switch C, links 320 to switch D, or links 362 to switch F). The next (fourth) bit may be used to select which link to take in the path to group 340 (e.g., which of links 360 to switch E, links 364 to switch G, and links 366 to switch H). Finally, the next (fifth) bit may be used to select which link to take in the path to the destination switch G (e.g., links 344, 348, or 352). Thus, in system 300 in FIG. 3, five bits may be used to represent, indicate, or map to 24 paths as depicted (or up to 32 possible paths). In some aspects, the address bits may be used to select an intermediate switch, where the hardware can select among the paths in a cable based on current load or congestion metrics. The usage of bits described herein is provided as an example only. Other mappings or selections of bits to links, paths, or network devices may be used.

Software in the control plane may determine how many bits of the address space of a destination address may be available to a user for the purposes described herein, i.e., performing deterministic forwarding in an adaptive forwarding system. This can result in achieving, in a single system, the improvements associated with using both deterministic and adaptive forwarding. Using the aspects described herein and in relation to FIG. 3, a user may design the software to execute or perform deterministic forwarding algorithms or a hybrid deterministic/adaptive forwarding algorithm. The user can program a system such that the selection of the type of forwarding algorithm can be a firm choice (e.g., set as a default or configured by the system), a choice dependent upon an error rate determined for one or more path (e.g., whether a path is entirely error free or indicates an error rate below a certain threshold), or a choice or preference indicated by the user upon startup or initialization of the system or at any time while the system is running.

Thus, the described aspects can provide a choice of using a deterministic forwarding algorithm or a hybrid deterministic/adaptive forwarding algorithm. This choice may also be based on the class of traffic and may allow applications which use the hybrid method to share a network with applications using adaptive algorithms. In processing a packet, a network device can determine that the packet indicates a type of application associated with the packet. The network device may determine that the type of the indicated application corresponds to an application to which the deterministic forwarding algorithm is to be applied. As a result, the system can allocate a (e.g., large) subset of the available paths to such an application and can allocate a (e.g., small) subset of the available paths to services related to operation of the system. This may result in service traffic being deflected from application paths, which can ensure dedicated network paths for traffic associated with the indicated application.

By providing users with the option of deterministic control over path selection, the described aspects can be combined with adaptive forwarding over equivalent paths, e.g., a pair of links in a dual-link cable, as depicted above in relation to links 312-322, 342-352, and 360-362 in FIG. 3. Combining and supporting both deterministic and adaptive forwarding in a single system can result in achieving the improvements in efficiency associated with each of these forwarding methods.

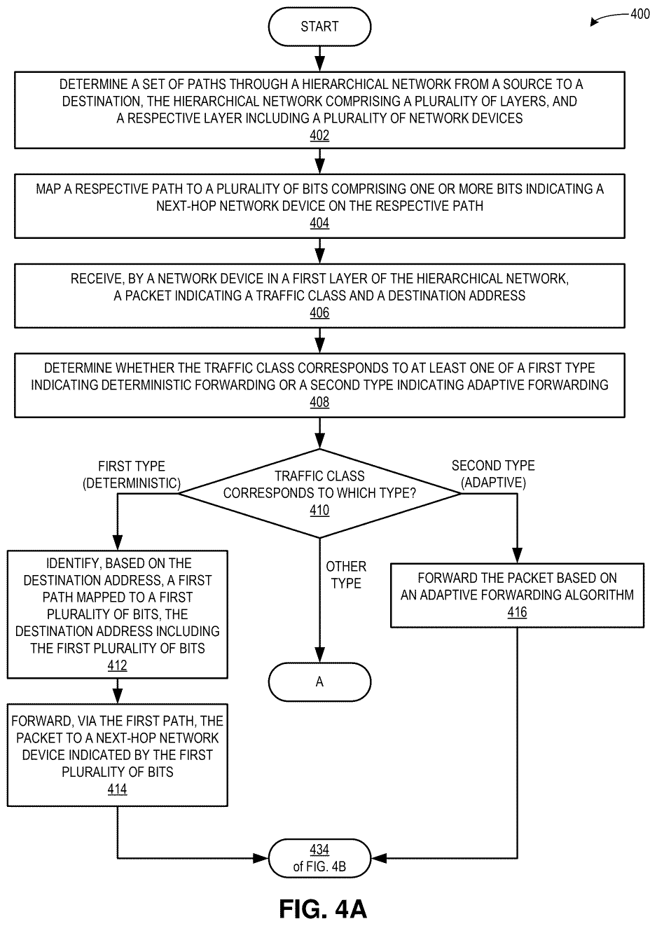

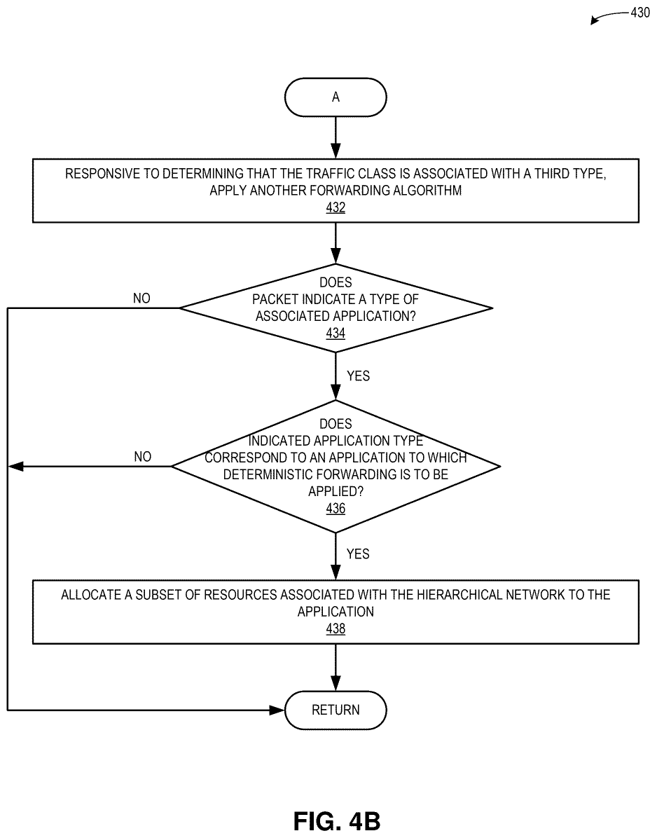

FIG. 4A presents a flowchart 400 illustrating a method which facilitates mixing deterministic and adaptive forwarding in a high-speed network, in accordance with an aspect of the present application. During operation, the system determines a set of paths through a hierarchical network from a source to a destination, the hierarchical network comprising a plurality of layers, and a respective layer including a plurality of network devices (operation 402). The system may determine the set of paths based on control information exchanged between the network devices in the hierarchical network. The control information may be exchanged when a new network device joins the hierarchical network, at periodic intervals, or based on other conditions for distribution and exchange of information related to the paths or links between the network devices. The hierarchical network may be, e.g., a dragonfly network, as described above in relation to FIGS. 2A and 2B. The set of paths may include connections with dual-link cables, both between network devices in the same group (e.g., as a first layer of all-to-all connections in a hierarchical network) and among network devices in different groups between the groups (e.g., a second layer of all-to-all connections between multiple groups, as depicted above in relation to elements 212 and 220 of FIGS. 2A and 2B).

The system maps a respective path to a plurality of bits comprising one or more bits indicating a next-hop network device on the respective path (operation 404). The plurality of bits may include bits to select paths, including between one or more switches or next hops or links in a network. For example, in system 300 of FIG. 3, two bits (e.g., of a destination address) may be used to select a first local switch in group 310, while up to three additional bits may be used to select a link to use at each hop.

The system receives, by a network device in a first layer of the hierarchical network, a packet indicating a traffic class and a destination address (operation 406). The packet may originate from a source, e.g., switch B of group 310 in FIG. 3, and may indicate a traffic class corresponding to either deterministic or adaptive forwarding. The packet may also include an address for a destination, e.g., switch G of group 340 in FIG. 3. System 300 may represent a switch fabric (such as switch fabric 110 in FIG. 1), and the packet may be first received by source switch B from a source processing or endpoint node with eventual transmission on from destination switch G to a target processing or endpoint node. For example, switch B of group 310 in FIG. 3 may correspond to switch 0.1 of group_0 in FIG. 1A, while destination switch G of group 340 in FIG. 3 may correspond to switch 288.14 in group_288 in FIG. 1A. The source node 230 may be node 15, while the destination node 230 may be node 36,976.

The system determines whether the traffic class corresponds to at least one of a first type indicating deterministic forwarding or a second type indicating adaptive forwarding (operation 408) (or another type, as described below in relation to operation 432 of FIG. 4B). The system may determine the traffic class type by extracting information from a header of a packet. The traffic class type may be indicated in the packet header, e.g., as a flag, one or more bits, or a value or element in a field.

Responsive to the traffic class corresponding to the first type (decision 410), the system applies a deterministic forwarding algorithm. The system may use any type of deterministic forwarding algorithm, in which the paths are predefined and mapped to the appropriate plurality of bits. The system identifies, based on the destination address, a first path mapped to a first plurality of bits, the destination address including the first plurality of bits (operation 412). For example, five bits may be used to identify the mapped path of the available paths in system 300 of FIG. 3: two bits to determine the local switch with global links to which the packet should be forwarded from source switch B; and three bits to determine which link to use at each hop.

The system forwards, via the first path, the packet to a next-hop network device indicated by the first plurality of bits (operation 414) and the operation continues at operation 434 of FIG. 4B. Continuing with the example of FIG. 3, the first path may be mapped to: two bits which indicate switch D as the next-hop network device (from source switch B, selected from switches A, C, and D in group 310 and the direct link to switch F in group 340); a bit which indicates which cable to use of dual-link cable 320 (from switch B to switch D); a bit to indicate which cable to use of dual-link cable 366 (from switch D to switch H); and a bit to indicate which link to use in cable 352 (from switch H to the destination switch G). As described above, the number of the first plurality of bits is indicated as five bits for illustrative purposes only. Other numbers of bits may be used and may depend on, e.g., the number of switches, groups, or links in multi-link cables, etc.

Responsive to the traffic class corresponding to the second type (decision 410), the system forwards the packet in accordance with an adaptive forwarding algorithm based on information interpreted dynamically by the network device (operation 416). The operation continues at operation 434 of FIG. 4B. Examples of the dynamically interpreted information may include, but are not limited to: current load or congestion information related to the network device, neighbor devices, the group, or the overall system; a destination address indicated in the packet; local programming of the network device processing or handling the packet, where the local programming of that network device may be distinct from the local programming of other network devices in the same or a different group; and the error status of links and other network devices or switches in the system.

Responsive to the traffic class corresponding to another type (decision 410), the operation continues at Label A of FIG. 4B. Examples of other types of forwarding algorithms may be based on using the destination address as a key in the forwarding table, using a label included in packet as the key, and swapping labels of incoming packets and output labels.

FIG. 4B presents a flowchart 430 illustrating a method which facilitates mixing deterministic and adaptive forwarding in a high-speed network, continuing from the flowchart in FIG. 4A, in accordance with an aspect of the present application. Responsive to determining that the traffic class is associated with a third type (an “other” type), the system applies another forwarding algorithm (operation 432). The other forwarding algorithm may be, e.g., a deterministic or adaptive forwarding algorithm different than the one used in operations 412/414 and 416, respectively. The other forwarding algorithm may also be a hybrid forwarding algorithm which includes both deterministic and adaptive forwarding, as described above in relation to selecting paths in a fat-tree network, in which either deterministic or adaptive forwarding may be used for packets traveling up or down the fat-tree network.

If the packet does not indicate a type of application associated with the packet (decision 434), the operation returns. If the packet does indicate a type of associated application (decision 434), the system determines whether the indicated application type corresponds to an application to which deterministic forwarding is to be applied (decision 436). This determination may be made by looking up the indicated application type in a data structure (e.g., a table or list) of applications and application types to which deterministic forwarding is to be applied. The table or list may be created or generated by a user and stored by the system. The table or list may also be generated based on user-configured or system-configured policies. The system may store the data structure in a distributed manner across a plurality of network devices in the hierarchical network, in a single network device in the hierarchical network, or in an external network device which is not part of the hierarchical network. The data structure may be accessed by a lookup in a memory of the network device processing the packet. The data structure may also be accessed based on a query to one or more other network devices in the hierarchical network or to an external network device.

If the indicated application type does not correspond to an application to which deterministic forwarding is to be applied (decision 436), the operation returns. If, however, the indicated application type does correspond to an application to which deterministic forwarding is to be applied (decision 436), the system allocates a subset of resources associated with the hierarchical network to the application (operation 438). For example, if an application is a high-priority application, the system may allocate a “significantly large” subset of available paths for traffic associated with the application. At the same time, the system can allocate a “significantly small” subset of the available paths for traffic related to system operations. The size of the significantly large or significantly small subsets may be determined based on a preconfigured threshold or percentage. In some aspects, the size may be based on the current load and resources (e.g., paths) in use at a given time. The operation returns.

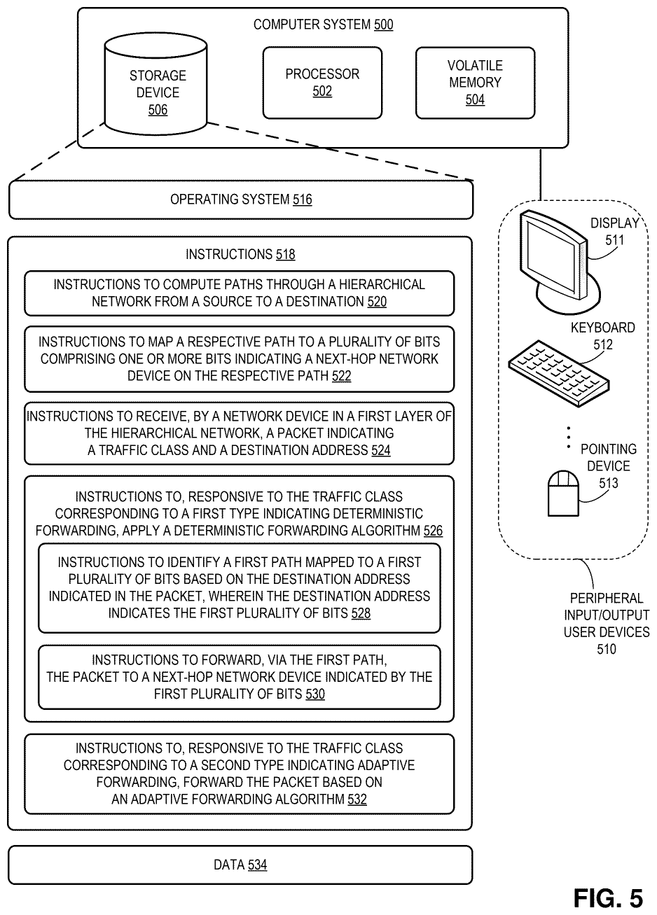

FIG. 5 illustrates a computer system which facilitates mixing deterministic and adaptive forwarding in a high-speed network, in accordance with an aspect of the present application. Computer system 500 includes a processor 502, a memory 504, and a storage device 506. Memory 504 may include a volatile memory (e.g., random access memory (RAM)) that serves as a managed memory and can be used to store one or more memory pools. Furthermore, computer system 500 may be coupled to peripheral I/O user devices 510 (e.g., a display device 511, a keyboard 512, and a pointing device 513). Storage device 506 includes non-transitory computer-readable storage medium and stores an operating system 516, instructions 518, and data 534. Computer system 500 may include fewer or more entities or instructions than those shown in FIG. 5.

Instructions 518 can include instructions, which when executed by computer system 500, can cause computer system 500 to perform methods and/or processes described in this disclosure. Specifically, instructions 518 may include instructions 520 to compute paths through a hierarchical network from a source to a destination, wherein the hierarchical network comprises a plurality of layers and a respective layer includes a plurality of network devices, as described above in relation to operation 402 of FIG. 4A. The hierarchical network may be a dragonfly network with a plurality of groups of network devices, where the network devices in each group may be associated with a first layer of the hierarchical network and are connected to each other in an all-to-all manner. The plurality of groups (i.e., the multiple groups) may be associated with a second layer of the hierarchical network. The groups (e.g., the network devices in the multiple groups) may be connected to each other via a plurality of global links in an all-to-all manner. Furthermore, a network device may be coupled to one or more endpoint or processing nodes. A dragonfly network is described above in relation to FIGS. 2A, 2B, and 3.

Instructions 518 may include instructions 522 to map a respective path to a plurality of bits comprising one or more bits indicating a next-hop network device on the respective path. The one or more bits may indicate paths, including over links between switches in the same group and over global links between switches in different groups, as described above in relation to system 300 of FIG. 3.

Instructions 518 may include instructions 524 to receive, by a network device in a first layer of the hierarchical network, a packet indicating a traffic class and a destination address, as described above in relation to operation 406 of FIG. 4A and the communications in system 300 of FIG. 3. The packet may indicate the destination address as a fabric address (e.g., a Layer-2 address of a switch in switch fabric 110 of FIG. 1) or a destination media access control (DMAC) address in a network based on Ethernet protocol.

Instructions 518 may include instructions 526 to, responsive to the traffic class corresponding to a first type indicating deterministic forwarding, apply a deterministic forwarding algorithm. Instructions 526 may include: instructions 528 to identify a first path mapped to a first plurality of bits based on the destination address indicated in the packet, wherein the destination address includes the first plurality of bits; and instructions 530 to forward, via the first path, the packet to a next-hop network device indicated by the first plurality of bits, as described above in relation to decision 410 and operations 412 and 414 of FIG. 4A.

Instructions 518 may include instructions 532 to, responsive to the traffic class corresponding to a second type indicating adaptive forwarding, forward the packet based on an adaptive forwarding algorithm in accordance with information interpreted dynamically by the network device, as described above in relation to decision 410 and operation 416 of FIG. 4A.

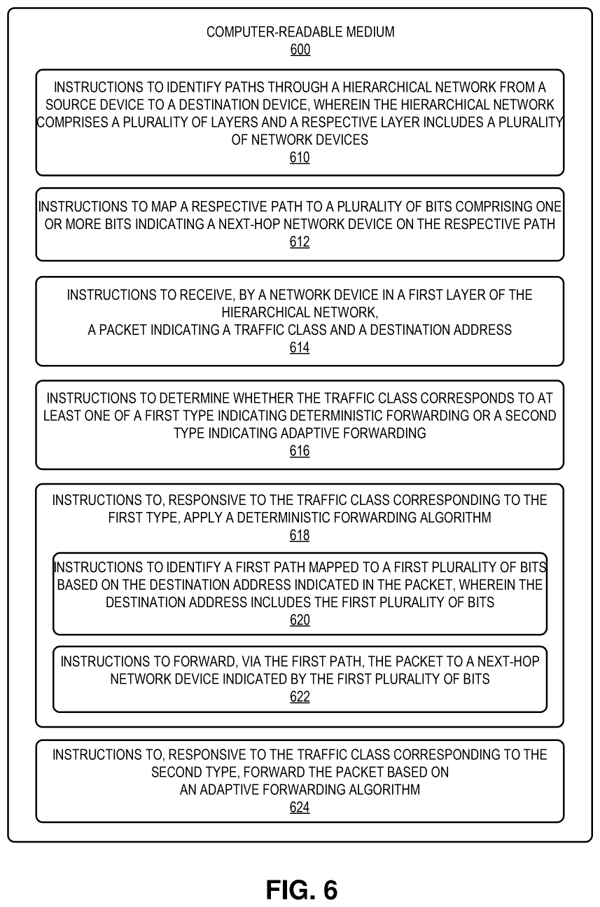

Instructions 518 may include more instructions than those shown in FIG. 5. For example, instructions 518 may include instructions for executing the operations described above in relation to: the environment of FIG. 1; the communications and operations of FIGS. 2A, 2B, and 3; the operations depicted in the flowcharts of FIGS. 4A and 4B; and the instructions of CRM 600 in FIG. 6.

Data 534 can include any data that is required as input or that is generated as output by the methods, operations, communications, and/or processes described in this disclosure. Specifically, data 534 can store at least: an indicator of a link or a path; a set of paths; an indicator of a topology for a network, including a hierarchical network, a fat-tree network, or a dragonfly network; an identifier of a network device or a group in a hierarchical network; an identifier of a link between network devices in a same group or a link between groups of network devices; a packet; a traffic class; a type of traffic class; an address; a destination address; a source address; a bit; a plurality of bits; one or more bits mapped to a path; one or more bits indicating a next-hop network device on a path; a type corresponding to deterministic forwarding, adaptive forwarding, or a hybrid or mix of deterministic and adaptive forwarding; information interpreted by a network device; a user-set traffic type; an indicator of an end node, a processing node, or an endpoint; an indicator or identifier of a local network device, a remote network device, or a destination network device; a type of application associated with a packet; an indicator of whether an application type corresponds to an application to which deterministic forwarding is to be applied; an indicator or identifier of a set of resources allocated for an application; information associated with communicating based on an Ethernet protocol; a destination MAC address; and information associated with load or congestion of a link or a path.

FIG. 6 illustrates a computer-readable medium which facilitates mixing deterministic and adaptive forwarding in a high-speed network, in accordance with an aspect of the present application. CRM 600 can be a non-transitory computer-readable medium or device storing instructions that when executed by a computer or processor cause the computer or processor to perform a method. CRM 600 may store instructions 610 to identify paths through a hierarchical network from a source device to a destination device, wherein the hierarchical network comprises a plurality of layers and a respective layer includes a plurality of network devices, as described above in relation to, e.g., the networks of FIGS. 2A, 2B, and 3, and instructions 520 of FIG. 5. CRM 600 may store instructions 612 to map a respective path to a plurality of bits comprising one or more bits indicating a next-hop network device on the respective path, as described above in relation to operation 404 of FIG. 4A and instructions 522 of FIG. 5.

CRM 600 may also store instructions 614 to receive, by a network device in a first layer of the hierarchical network, a packet indicating a traffic class and a destination address, as described above in relation to operation 406 of FIG. 4A and instructions 524 of FIG. 5. CRM 600 may store instructions 616 to determine whether the traffic class corresponds to at least one of a first type indicating deterministic forwarding or a second type indicating adaptive forwarding, as described above in relation to operation 408 of FIG. 4A.

CRM 600 may further store instructions 618 to, responsive to the traffic class corresponding to the first type, apply a deterministic forwarding algorithm, as described above in relation to decision 410 of FIG. 4A. Instructions 618 may include: instructions 620 to identify a first path mapped to a first plurality of bits based on the destination address indicated in the packet, wherein the destination address includes the first plurality of bits; and instructions 622 to forward, via the first path, the packet to a next-hop network device indicated by the first plurality of bits, as described above in relation to operations 412 and 414 of FIG. 4A.

CRM 600 may store instructions 624 to, responsive to the traffic class corresponding to the second type, forward the packet based on an adaptive forwarding algorithm in accordance with information interpreted dynamically by the network device, as described above in relation to decision 410 and operation 416 of FIG. 4A.

CRM 600 may include more instructions than those shown in FIG. 6. For example, CRM 600 may also store instructions for executing the operations described above in relation to: the environment of FIG. 1; the communications and operations of FIGS. 2A, 2B, and 3; the operations depicted in the flowcharts of FIGS. 4A and 4B; and instructions 518 of computer system 500 in FIG. 5.

The described aspects illustrate a dragonfly network (e.g., in FIGS. 2A and 2B) as the hierarchical network for illustrative purposes only. The described aspects may be applied to any hierarchical network, including a fat-tree network (as described above in relation to FIG. 2C). Furthermore, the described addressing scheme may be associated with fabric addresses of network devices in an HPC system, but other addressing schemes may be used. For example, the network devices may communicate based on an Ethernet protocol and such a network device may locally manage the destination media access control (DMAC) address. In general, the Ethernet DMAC can be a 48-bit field, and the number of DMACs in use in any given subnet may generally be small or even assigned by software. As a result, much of the DMAC address space may be open or unused, and thus available for use in the manner described herein.

The term “network device” refers to any device, component, or computing entity which can provide a communication pipeline for packets sent from a “processing node” or an “endpoint node.” A processing or endpoint node can refer to a device, component, or hardware component which can operate as a source or a destination of data, including e.g., a control packet or a data packet. An example of a network device may be a switch, and an example of a processing or endpoint node may be a network interface controller (NIC), as described above in relation to FIGS. 2A, 2B, and 3.

The term “high-speed network” refers to a network with may offer download or communication speeds which are faster than average, e.g., at a certain Megabits per second (Mbps) (such as 25 Mbps) or faster. An example of a high-speed network may be an HPC system, an HPC environment, or any computing or networking environment in which components such as networking, memory, storage, and file systems may provide high speed and high throughput when compared to average thresholds.

In general, the disclosed aspects provide a method, a computer system, and a computer-readable medium which facilitate mixing deterministic and adaptive forwarding in a high-speed network. During operation, the system determines a set of paths through a hierarchical network from a source to a destination, the hierarchical network comprising a plurality of layers, and a respective layer including a plurality of network devices. The system maps a respective path to a plurality of bits comprising one or more bits indicating a next-hop network device on the respective path. The system receives, by a network device in a first layer of the hierarchical network, a packet indicating a traffic class and a destination address. Responsive to the traffic class corresponding to a first type, the system applies a deterministic forwarding algorithm by: identifying, based on the destination address, a first path mapped to a first plurality of bits, the destination address including the first plurality of bits; and forwarding, via the first path, the packet to a next-hop network device indicated by the first plurality of bits. Responsive to the traffic class corresponding to a second type, the system forwards the packet in accordance with an adaptive forwarding algorithm based on information interpreted dynamically by the network device.

In a variation on this aspect, the system allows a user to set a type for the traffic class. The system applies, based on the traffic class type set by the user, one of the deterministic forwarding algorithm and the adaptive forwarding algorithm for forwarding the packet.

In a further variation on this aspect, the hierarchical network comprises a dragonfly network which includes a plurality of groups of network devices. The network devices in a respective group comprise a first layer of the hierarchical network and are connected to each other in an all-to-all manner. The groups in the plurality of groups comprise a second layer of the hierarchical network and are connected to each other via a plurality of global links in an all-to-all manner. A respective network device is coupled to one or more endpoint or processing nodes.

In a further variation, a first set of the plurality of bits indicates a next-hop network device comprising at least one of: a local network device in a same group as the network device; a remote network device in a different group from the network device, the remote network device connected to the same group as the network device based on a global link; or the destination network device. A second set of the plurality of bits indicates a link to be used at the next-hop network device. A third set of the plurality of bits indicates a link of a plurality of links to use to reach the destination network device.

In a further variation, the hierarchical network comprises a fat-tree network which includes groups of network devices as nodes arranged in a tree-like structure. The tree-like structure includes a core network device at the top of the tree-like structure and processing nodes at the bottom of the tree-like structure. A number of links going down from a node to its children is equal to or greater than a number of links going up to its parent.

In a further variation, the system applies the deterministic or adaptive forwarding algorithm in response to the packet traveling up the fat-tree towards the core network device. The system applies the deterministic or adaptive forwarding algorithm in response to the packet traveling down the fat-tree network towards the processing nodes.

In a further variation, the system determines that the traffic class is associated with a third type. The system applies another forwarding algorithm comprising at least one of: another deterministic forwarding algorithm; or another adaptive forwarding algorithm.

In a further variation, the system determines that the packet further indicates a type of application associated with the packet. The system determines that the type of application corresponds to an application to which the deterministic forwarding algorithm is to be applied. The system allocates a subset of resources associated with the hierarchical network to the application.

In a further variation, network devices in the hierarchical network communicate based on an Ethernet protocol, and a destination media access control (MAC) address is managed locally by a respective network device.

In another aspect, a computer system comprises a processor and a storage device storing instructions. The instructions are to compute paths through a hierarchical network from a source to a destination, wherein the hierarchical network comprises a plurality of layers and a respective layer includes a plurality of network devices. The instructions are further to map a respective path to a plurality of bits comprising one or more bits indicating a next-hop network device on the respective path. The instructions are further to receive, by a network device in a first layer of the hierarchical network, a packet indicating a traffic class and a destination address. The instructions are further to, responsive to the traffic class corresponding to a first type indicating deterministic forwarding, apply a deterministic forwarding algorithm by: identifying a first path mapped to a first plurality of bits based on the destination address indicated in the packet, wherein the destination address includes the first plurality of bits; and forwarding, via the first path, the packet to a next-hop network device indicated by the first plurality of bits. The instructions are further to, responsive to the traffic class corresponding to a second type indicating adaptive forwarding, forward the packet based on an adaptive forwarding algorithm in accordance with information interpreted dynamically by the network device. The computer system may include a content-processing system which includes instructions to perform the operations described herein, including in relation to: the environment of FIG. 1; the networks of FIGS. 2A, 2B, and 3; the operations depicted in the flowcharts of FIGS. 4A and 4B; and the instructions of CRM 600 in FIG. 6.

In another aspect, a non-transitory computer-readable storage medium (or CRM) stores instructions to identify paths through a hierarchical network from a source to a destination, wherein the hierarchical network comprises a plurality of layers and a respective layer includes a plurality of network devices. The instructions are further to map a respective path to a plurality of bits comprising one or more bits indicating a next-hop network device on the respective path. The instructions are further to receive, by a network device in a first layer of the hierarchical network, a packet indicating a traffic class and a destination address. The instructions are further to determine whether the traffic class corresponds to at least one of a first type indicating deterministic forwarding or a second type indicating adaptive forwarding. The instructions are further to, responsive to the traffic class corresponding to the first type, apply a deterministic forwarding algorithm by: identifying a first path mapped to a first plurality of bits based on the destination address indicated in the packet, wherein the destination address includes the first plurality of bits; and forwarding, via the first path, the packet to a next-hop network device indicated by the first plurality of bits. The instructions are further to, responsive to the traffic class corresponding to the second type, forward the packet based on an adaptive forwarding algorithm in accordance with information interpreted dynamically by the network device. The CRM can also store instructions for executing the operations described above in relation to: the environment of FIG. 1; the networks of FIGS. 2A, 2B, and 3; the operations depicted in the flowcharts of FIGS. 4A and 4B; and instructions 518 of computer system 500 in FIG. 5.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
determining a set of paths through a hierarchical network from a source to a destination, the hierarchical network comprising a plurality of layers, and a respective layer including a plurality of network devices;
mapping a respective path to a plurality of bits comprising one or more bits indicating a next-hop network device on the respective path;
receiving, by a network device in a first layer of the hierarchical network, a packet indicating a traffic class and a destination address;
responsive to the traffic class corresponding to a first type, applying a deterministic forwarding algorithm by:
identifying, based on the destination address, a first path mapped to a first plurality of bits, wherein the destination address includes the first plurality of bits; and
forwarding, via the first path, the packet to a next-hop network device indicated by the first plurality of bits; and
responsive to the traffic class corresponding to a second type, forwarding the packet in accordance with an adaptive forwarding algorithm based on information interpreted dynamically by the network device.

2. The method of claim 1, the method further comprising:
allowing a user to set a type for the traffic class; and
applying, based on the traffic class type set by the user, one of the deterministic forwarding algorithm and the adaptive forwarding algorithm for forwarding the packet.

3. The method of claim 1,
wherein the hierarchical network comprises a dragonfly network which includes a plurality of groups of network devices,
wherein the network devices in a respective group comprise a first layer of the hierarchical network and are connected to each other in an all-to-all manner,
wherein the groups in the plurality of groups comprise a second layer of the hierarchical network and are connected to each other via a plurality of global links in an all-to-all manner, and
wherein a respective network device is coupled to one or more endpoint or processing nodes.

4. The method of claim 3,
wherein a first set of the plurality of bits indicates a next-hop network device comprising at least one of:
a local network device in a same group as the network device;
a remote network device in a different group from the network device, the remote network device connected to the same group as the network device based on a global link; or
the destination network device;
wherein, in response to a choice of paths remaining, a second set of the plurality of bits indicates a link to be used at the next-hop network device; and
wherein, in response to a choice of paths remaining, a third set of the plurality of bits indicates a link of a plurality of links to use to reach the destination network device.

5. The method of claim 1,
wherein the hierarchical network comprises a fat-tree network which includes groups of network devices as nodes arranged in a tree-like structure;
wherein the tree-like structure includes a spine network device at the top of the tree-like structure and processing nodes at the bottom of the tree-like structure; and
wherein a number of links going down from a node to its children is equal to or greater than a number of links going up to its parent.

6. The method of claim 5, further comprising:
applying the deterministic or adaptive forwarding algorithm in response to the packet traveling up the fat-tree towards the core network device; and
applying the deterministic or adaptive forwarding algorithm in response to the packet traveling down the fat-tree network towards the processing nodes.

7. The method of claim 1, further comprising:
determining that the traffic class is associated with a third type; and
applying another forwarding algorithm comprising at least one of:
another deterministic forwarding algorithm; or
another adaptive forwarding algorithm.

8. The method of claim 1, further comprising:
determining that the packet further indicates a type of application associated with the packet;
determining that the type of application corresponds to an application to which the deterministic forwarding algorithm is to be applied; and
allocating a subset of resources associated with the hierarchical network to the application.

9. The method of claim 1,
wherein network devices in the hierarchical network communicate based on an Ethernet protocol, and
wherein a destination media access control (MAC) address is managed locally by a system associated with a respective network device.

10. A computer system, comprising:
a processor; and
a storage device storing instructions to:
compute paths through a hierarchical network from a source to a destination, wherein the hierarchical network comprises a plurality of layers and a respective layer includes a plurality of network devices;
map a respective path to a plurality of bits comprising one or more bits indicating a next-hop network device on the respective path;
receive, by a network device in a first layer of the hierarchical network, a packet indicating a traffic class and a destination address;
responsive to the traffic class corresponding to a first type indicating deterministic forwarding, apply a deterministic forwarding algorithm by:
identifying a first path mapped to a first plurality of bits based on the destination address indicated in the packet, wherein the destination address includes the first plurality of bits; and
forwarding, via the first path, the packet to a next-hop network device indicated by the first plurality of bits; and
responsive to the traffic class corresponding to a second type indicating adaptive forwarding, forward the packet based on an adaptive forwarding algorithm in accordance with information interpreted dynamically by the network device.

11. The computer system of claim 10, wherein the instructions are further to:
determine a user-configured type for the traffic class; and
apply, based on the user-configured traffic class type, one of the deterministic forwarding algorithm and the adaptive forwarding algorithm for forwarding the packet.

12. The computer system of claim 10,
wherein the hierarchical network comprises a dragonfly network which includes a plurality of groups of network devices,
wherein the network devices in a respective group comprise a first layer of the hierarchical network and are connected to each other in an all-to-all manner,
wherein the groups in the plurality of groups comprise a second layer of the hierarchical network and are connected to each other via a plurality of global links in an all-to-all manner, and
wherein a respective network device is coupled to one or more endpoint or processing nodes.

13. The computer system of claim 12,
wherein a first set of the plurality of bits indicates a next-hop network device,
wherein the next-hop device comprises at least one of:
a local network device in a same group as the network device;
a remote network device in a different group from the network device, the remote network device connected to the same group as the network device based on a global link; or
the destination network device,
wherein, in response to a choice of paths remaining, a second set of the plurality of bits indicates a link to be used at the next-hop network device, and
wherein, in response to a choice of paths remaining, a third set of the plurality of bits indicates a link of a plurality of links to use to reach the destination network device.

14. The computer system of claim 10,
wherein the hierarchical network comprises a fat-tree network which includes groups of network devices as nodes arranged in a tree-like structure;
wherein the tree-like structure includes a spine network device at the top of the tree-like structure and processing nodes at the bottom of the tree-like structure; and
wherein a number of links going down from a node to its children is equal to or greater than a number of links going up to its parent.

15. The computer system of claim 5, wherein the instructions are further to:
apply the deterministic or adaptive forwarding algorithm in response to the packet traveling up the fat-tree towards the core network device; and
apply the deterministic or adaptive forwarding algorithm in response to the packet traveling down the fat-tree network towards the processing nodes.

16. The computer system of claim 10, wherein the instructions are further to:
determine that the traffic class is associated with a third type; and
apply another forwarding algorithm comprising at least one of:
another deterministic forwarding algorithm;
another adaptive forwarding algorithm; or
a hybrid forwarding algorithm including deterministic and adaptive forwarding.

17. The computer system of claim 10, wherein the instructions are further to:
identify, based on information indicated in the packet, a type of application associated with the packet;
determine that the type of application corresponds to an application to which the deterministic forwarding algorithm is to be applied; and
allocate a subset of resources associated with the hierarchical network to the application.

18. The computer system of claim 10,
wherein network devices in the hierarchical network communicate based on an Ethernet protocol, and
wherein a destination media access control (MAC) address is managed locally by a system associated with a respective network device.

19. A non-transitory computer-readable medium storing instructions to:
identify paths through a hierarchical network from a source device to a destination device, wherein the hierarchical network comprises a plurality of layers and a respective layer includes a plurality of network devices;
map a respective path to a plurality of bits comprising one or more bits indicating a next-hop network device on the respective path;
receive, by a network device in a first layer of the hierarchical network, a packet indicating a traffic class and a destination address;
determine whether the traffic class corresponds to at least one of a first type indicating deterministic forwarding or a second type indicating adaptive forwarding;
responsive to the traffic class corresponding to the first type, apply a deterministic forwarding algorithm by:
identifying a first path mapped to a first plurality of bits based on the destination address indicated in the packet, wherein the destination address includes the first plurality of bits; and
forwarding, via the first path, the packet to a next-hop network device indicated by the first plurality of bits; and
responsive to the traffic class corresponding to the second type, forward the packet based on an adaptive forwarding algorithm in accordance with information interpreted dynamically by the network device.

20. The non-transitory computer-readable medium of claim 19,
wherein the hierarchical network comprises a dragonfly network which includes a plurality of groups of network devices;
wherein the network devices in a respective group comprise a first layer of the hierarchical network and are connected to each other in an all-to-all manner;
wherein the groups in the plurality of groups comprise a second layer of the hierarchical network and are connected to each other via a plurality of global links in an all-to-all manner; and
wherein a respective network device is coupled to one or more endpoint or processing nodes.
